(19) United States
(12) Patent Application Publication
(10) Pub. No.: US 2020/0102253 A1
(43) Pub. Date: Apr. 2, 2020

(54) FIBER COMPOSITE COMPONENT AND PRODUCTION METHOD

(71) Applicant: SCHUNK KOHLENSTOFFTECHNIK GMBH, Heuchelheim (DE)

(72) Inventors: Roland Weiss, Huettenberg (DE); Gotthard Nauditt, Huettenberg (DE); Thomas Wamser, Werbach (DE)

(21) Appl. No.: 16/604,767

(22) PCT Filed: Mar. 28, 2018
(86) PCT No.: PCT/EP2018/058005

§ 371 Date: Oct. 11, 2019

(30) Foreign Application Priority Data
Apr. 13, 2017 (DE) 10 2017 206 452.8

(51) Int. Cl. C04B 35/80; C04B 35/106; C04B 35/185; C04B 35/565; C04B 35/584; C04B 35/505

(52) U.S. Cl. CPC C04B 35/80; C04B 2235/6026; C04B 35/185; C04B 35/565; C04B 35/584; C04B 35/505; C04B 2235/5264; C04B 2235/5244; C04B 2235/5236; C04B 2235/5228; C04B 2235/5224; C04B 2235/5248; C04B 2235/5436; C04B 2235/6021; C04B 2235/764; C04B 2235/6027; C04B 35/106

(57) ABSTRACT

A method for producing a fiber composite component and a fiber composite component for high-temperature applications. In particular, a workpiece carrier for providing and handling workpieces in high-temperature furnaces for high-temperature treatments or the like, a dimensionally stable green body of the fiber composite component being realized from a matrix material reinforced with fibers, said fiber composite component being realized by means of a heat treatment of the green body, a fiber being extruded together with a slip as a matrix material from a nozzle and being spatially arranged in such a manner that the green body is realized by means of additive manufacturing.

This application represents the national stage entry of PCT International Application No. PCT/EP2018/058005 filed Mar. 28, 2018, which claims priority of German Patent Application No. 10 2017 206 452.8, filed Apr. 13, 2017, the disclosures of which are incorporated by reference here in their entirety for all purposes.

The disclosure relates to a fiber composite component as well as to a method for producing a fiber composite component for high-temperature applications, in particular a workpiece carrier for providing and handling workpieces in high-temperature furnaces for high-temperature treatments or the like, a dimensionally stable green body of the fiber composite component being realized from a matrix material reinforced with fibers, said fiber composite component being realized by means of a heat treatment of the green body.

Fiber composite components and workpiece carriers are sufficiently known and are routinely used for receiving and transporting workpieces in the context of high-temperature treatments. By high-temperature treatment, a workpiece treatment in a high-temperature furnace at a temperature of more than 1.000° C. is meant here. Workpieces that consist of metal, for instance of steel, are, for instance, annealed in the context of high-temperature treatments in order to achieve an improvement of the properties of the relevant workpiece. It may also be envisaged that workpieces are coated in the context of a high-temperature treatment. In the known treatment methods, it is always the aim to arrange a large number of workpieces on workpiece carriers in such a way that an interior of the high-temperature furnace is filled as densely as possible with workpieces in order to keep the costs of the treatment method low. Here, the workpieces are arranged on the workpiece carrier in such a way that the workpieces are exposed to a furnace atmosphere on all sides, if possible, in order to achieve a homogeneous heating of the respective workpieces.

The known workpiece carriers are routinely formed from a plate-shaped support grid, which can also realize a grid structure. Although it is also known to realize the support grid from metal, a support grid that is made of metal can easily go out of shape or sag at high temperatures. Workpieces or support grids that are realized from carbon-fiber-reinforced carbon (CFC) are, in contrast, dimensionally stable and sufficiently hard at high temperatures, too. If the carbon of the workpiece carrier, in a high-temperature treatment of workpieces, is supposed to be prevented from contaminating the material of the workpieces, for instance through a carburization of steel, the workpiece carrier may include a ceramic separating layer for placing workpieces on said layer or be realized from ceramic materials itself.

From DE 19 957 906 A1, a method for producing a fiber composite component or a workpiece carrier is known in which fibers are arranged according to a grid structure and sewn together at intersecting points. In this way, a particularly high fiber volume can be achieved at intersecting points of the grid structure. The fiber composite that is realized in this manner is infiltrated with a resin as a matrix material and is introduced into a mold. The resin is cured so that a dimensionally stable green body or a precursor is obtained, which is at the end made into the workpiece carrier by means of a heat treatment, in particular by means of a pyrolysis of the resin. Through a structured fiber arrangement that is oriented according to the grid structure, a stable fiber composite component can be obtained.

It may be required, due to the fact that workpiece carriers are used for providing and handling a wide variety of workpieces, to employ workpiece carriers having a wide variety of grid structures, depending on the size or shape of the workpieces. For producing such custom-made workpiece carriers, it is, however, always required to use a tool or a mold that has correspondingly been adapted. Since the fibers are, amongst other things, also pressed with the matrix material with the aid of such molds, the production of these molds is very expensive. There are, therefore, limits to an individualization of workpiece carriers.

The present disclosure is therefore based on the object to propose a fiber composite component and a method for producing the same that makes an inexpensive production possible.

This object is attained by a method having the features of claim 1 and by a fiber composite component having the features of claim 21.

In the method in accordance with the disclosure for producing a fiber composite component for high-temperature applications, in particular a workpiece carrier for providing and handling workpieces in high-temperature furnaces for high-temperature treatments or the like, a dimensionally stable green body of the fiber composite component is realized from a matrix material reinforced with fibers, said fiber composite component being realized by means of a heat treatment of the green body, wherein a fiber is extruded together with a slip as a matrix material from a nozzle and is spatially arranged in such a manner that the green body is realized by means of additive manufacturing.

An additive manufacturing becomes only possible due to the fact that the fiber is extruded from the nozzle together with the slip. The green body can then be realized so as to be, in principle, shapeless in that the fiber is deposited by the nozzle, together with the slip, on the basis of a data model of a shape of the green body. The nozzle is then moved along the shape of the green body during extrusion so that the green body is generated by applying the fiber with the slip. It then becomes possible to realize a fiber composite component or a workpiece carrier having almost any shape. It is then no longer required to use a mold with the aid of which impregnated fibers could be compressed, whereby the production costs of the mold can be saved and the fiber composite component can thus be produced at lower costs all in all.

It may in particular be envisaged to arrange the fibers in a structured fiber composite. As a consequence, it becomes possible to achieve a significantly increased fiber volume of the fiber composite component, which can substantially increase a rigidity of the fiber composite component. Besides, the fiber composite can then be oriented according to a direction of load. In particular when a grid structure is supposed to be realized, the fiber composite can always be arranged along struts of the grid structure.

It is advantageous if the slip is dimensionally stabilized after having been extruded, said dimensional stabilizing preferably being effected by drying, heat treating or curing a binder. In this way, the fiber can be coextruded together with the slip, in such a manner that the fiber adheres to an underground together with the slip. The underground may already be a fiber, a fiber layer or a fiber bundle, which realizes a shape of the fiber composite component al least in part. The slip may then easily make it possible for the fiber to adhere to said underground. Directly after the extrusion of the slip with the fiber, a dimensional stabilization of the slip may be envisaged, which is for instance possible by means of drying the slip, of a heat treatment, for instance by way of extraction or partial extraction of a dispersing agent at a predefined temperature and air humidity, or also by curing a binder, which may be contained in the slip. For instance, a binder container in the slip may also be cured by means of ultraviolet light and the slip may thus be fixed so as to be dimensionally stable. It is essential that the dimensional stabilization makes it possible to apply the fiber with the slip again in adjacent rows and planes or layers situated one above the other according to the shape of the fiber composite component, without the slip being moved due to its dead weight or due to a dead weight of the green body that is realized in this way or a shape of the green body being altered as a result of a flowing of the slip.

Optionally, the green body may be re-treated in a subsequent method step by way of pressing or vacuum molding. In this way, this additional shaping step can be carried out after an extraction or partial extraction of a dispersing agent. A fiber structure that has been deposited and infiltrated can then be compacted and formed, a final dimensional stabilization then being effected at the end.

It is particularly advantageous if the fiber is freely deposited during the extrusion. In this way, the fiber can be extruded from the nozzle together with the slip or conveyed and be applied, without any pressure, onto an underground or a fiber layer that is situated underneath said fiber. Here, the slip may coat the fiber already within the nozzle so that the slip adheres to the fiber and is deposited together with the fiber.

In principle, the green body may be realized so as to be shapeless or alternatively in a shape of the green body by way of an extrusion. When the green body is realized so as to be shapeless, the green body can be realized on a flat molding table or another flat underground by way of a continuous extrusion of the fiber together with the slip. Most fiber composite components, in particular workpiece carriers, can then be produced without using a mold. If a particularly reliable dimensional stability is supposed to be achieved or if the fiber composite component has a complex shape, it may be advantageous to use a mold into which the fiber is extruded together with the slip. The mold then includes an opening via which the nozzle may enter the mold or may deposit the fiber within the mold. An inorganic matrix material may be used as a matrix material, preferably a matrix material made from aluminum oxide, mullite (MgO), zirconium oxide, yttrium-aluminum garnet, silicon carbide and/or silicon nitride. The slip then substantially includes one of the above-mentioned substances or also mixtures thereof. These substances are present in the form of a powder or of particles. In this way, it is then also possible to realize a ceramic matrix material or a ceramic fiber composite component in the context of a heat treatment. If a workpiece carrier is realized from a ceramic fiber composite material, it is, owing to the fiber reinforcement, very stable, i.e. not brittle, and is resistant with respect to fast temperature changes. Moreover, a contamination of workpieces through carbon of the workpiece carrier can be prevented in that the workpiece carrier, at least at possible contact surfaces with workpieces, does not contain any carbon.

The slip may also include a dispersing agent, preferably water, glycerine and/or ethyl alcohol being used as the dispersing agent. The dispersing agent may then be mixed with particles of the matrix material in a volume ratio in which the slip can still be extruded through the nozzle easily and simultaneously does not tend to flow after leaving the nozzle.

In this way, it is particularly advantageous if the slip is thixotropic. The slip can then be liquid or viscous within the nozzle and may consolidate after leaving the nozzle. If the slip includes a dispersing agent that can evaporate quickly, a comparably dimensionally stable green body can already be obtained by means of an immediate heat treatment or drying of the slip.

Furthermore, the slip can include additives, a binding agent and/or an antifoaming agent being used as additives. The antifoaming agent can improve a workability of the slip. The binding agent can serve to consolidate the slip after an extrusion or also to cure the same. For instance, the binding agent may be a binding agent that can be activated with the aid of ultraviolet light or heat.

The slip may also include ceramic particles, preferably 20 percent by volume of small ceramic particles having a mean particle size of 0.1 μm and 80 percent by volume of large ceramic particles having a mean particle size of 1 to 5 μm being used. With such a ratio of small ceramic particles to large ceramic particles as well as with the mean particle sizes selected in each case, it becomes possible to realize the slip, upon extrusion, so as to have at least partially shear thickening or partially thixotropic behavior. Besides, a consolidation can be made possible by sintering, obtaining a porosity. The maximum particle sizes can be selected so as to enable a complete infiltration of a fiber bundle.

The slip may also have a solids content of 35 percent by volume to 55 percent by volume, particularly of 40 percent by volume. The remaining liquid components of the slip may then, for instance, be a dispersing agent. It also becomes possible to have a favorable impact on a behavior of the slip upon an extrusion through the nozzle with the aid of selecting a solids content.

An inorganic fiber can be used as the fiber, preferably a fiber made from aluminum oxide, mullite, zirconium oxide, yttrium-aluminum garnet, silicon carbide and/or silicon nitride. The inorganic fibers can then be combined with an oxide ceramic matrix made of a concordant or also made of a different matrix material. Furthermore, it may be envisaged to combine inorganic fibers from different materials with one another.

As an alternative, an organic fiber can be used as the fiber, preferably a fiber made from carbon. Carbon fibers are available at comparably low costs and are also dimensionally stable and sufficiently solid at high temperatures. For instance, the carbon fibers can then also be combined with an inorganic matrix material. With such a combination, attention has to be paid to the materials being thermomechanically and thermodynamically.

The fiber can have a diameter of 5 μm to 30 μm, preferably of 10 μm. Fibers having these diameters are particularly suitable for an extrusion from the nozzle together with the slip.

The fiber can be a continuous filament that can continuously be supplied to the nozzle. By using a continuous filament, it becomes possible to arrange the fiber without interruption, as upon winding the fiber, in a desired orientation, according to a shape of the fiber composite component. A rigidity of the fiber composite component can advantageously be increased in this way. In principle, it is, however, also possible to extrude short cut fibers from the nozzle together with the slip.

In order to be able to produce the green body as quickly as possible, a filament yarn can also be extruded from the nozzle together with the slip, said filament yarn having 1.000 den (denier) to 50.000 den, preferably 20.000 den. The filament yarn can then also already be soaked or impregnated with the slip within the nozzle. In particular due to the fact that a large number of fibers can then also be extruded from the nozzle at the same time, a fast additive generation of the green body from the filament yarn together with the slip is made possible.

The fiber composite component can advantageously be realized so as to have a fiber content of 10 percent by volume to 60 percent by volume, preferably of up to 35 percent by volume. A high fiber content promotes the rigidity properties of the fiber composite component.

The fiber composite component may be realized as a workpiece carrier that is made of a support grid for positioning workpieces on the workpiece carrier, said support grid then being made of support struts realizing a grid structure. Due to the fact that the fiber is placed by means of the nozzle, it then also becomes possible to realize the workpiece carrier in one piece. The green body then substantially corresponds to a preform that has a grid shape.

In this process, intersecting points or junction points of the grid structure can be realized so as to have the same material thickness and/or the same fiber content. A thickness or a cross-section surface of the support struts of the grid structure is then always constant. In particular, the fiber can be placed in such a way that the intersecting points or junction points of support struts that are connected to one another substantially have the same fiber volume as the support struts compared to the cross-section surface.

As a matter of principle, it can furthermore be envisaged to cure or stabilize the green body by way of a supplementary heat treatment before the green body is supplied to the final heat treatment for realizing the fiber composite component. In this heat treatment, the matrix material of the green body may be sintered.

The method in addition relates to using the nozzle for extruding the fiber together with the slip for producing the green body.

The fiber composite component in accordance with the disclosure for high-temperature applications, in particular a workpiece carrier for providing and handling workpieces in high-temperature furnaces for high-temperature treatments or the like, is realized from a dimensionally stable green body made from a matrix material reinforced with fibers, said fiber composite component being realized by means of a heat treatment of the green body, wherein the green body is realized by means of additive manufacturing by way of a spatial arrangement and of an extrusion of a fiber together with a slip as a matrix material from a nozzle. Regarding the advantageous effects of the fiber composite component in accordance with the disclosure, reference is made to the description of the advantages of the method in accordance with the disclosure. Further advantageous embodiments of the fiber composite component are the result of the descriptions of the features of the dependent claims that refer back to method claim 1.

In the following, a preferred embodiment of the disclosure is explained in more detail, with reference auf the enclosed drawing.

In the figures:

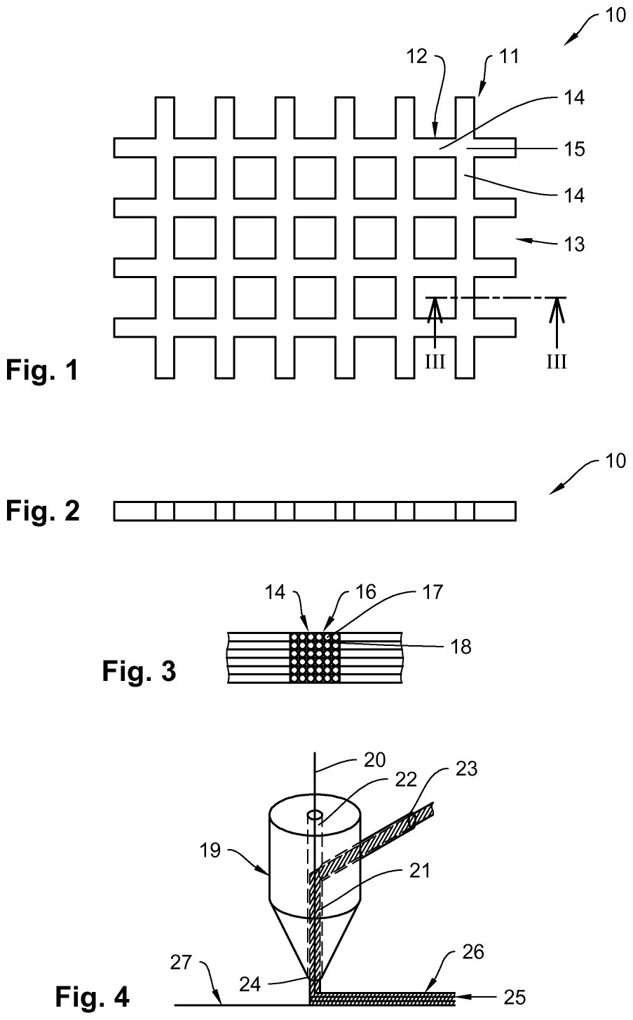

FIG. 1: shows a workpiece carrier in a view from above;

FIG. 2: shows the workpiece carrier in a side view;

FIG. 3: shows a partial sectional view of the workpiece carrier from FIG. 1 along a line III-III;

FIG. 4: shows a schematic illustration of a nozzle for producing a fiber composite component.

A combined view of FIGS. 1 to 3 shows a fiber composite component 11 that is realized as a workpiece carrier 10. The workpiece carrier 10 realizes a support grid 12 having a grid structure 13, said grid structure 13 being realized from support struts 14 that are connected in intersecting points 15.

As the partial sectional illustration in FIG. 3 shows, the support struts 14 and the intersecting points 15 are realized from a structured fiber composite 16 from fibers 17 that reinforce a matrix material. The fibers 17 as well as the matrix material 18 consist of an inorganic material, such as aluminum oxide. The fibers 17 were extruded from a nozzle together with a slip and were spatially deposited one on top of the other and one next to the other in the arrangement illustrated here. The slip was dimensionally stabilized after having been extruded so that a green body was realized by way of this manner of additive manufacturing. The green body was realized by means of a heat treatment so as to form the fiber composite component 11.

FIG. 4 shows a schematic illustration of a nozzle 19 with the aid of which a fiber 20 is extruded together with a slip 21. The nozzle 19 includes a channel 22 for supplying the fiber 20 and a channel 23 for supplying the slip 21. At one nozzle end 24, the fiber 20 leaves the nozzle 19 together with the slip 21 and is deposited in or on fiber layers 25 in a structured fashion without any pressure. The slip 21, which is still liquid upon leaving, consolidates when the fiber 20 is being deposited on the fiber layer 25 so that a green body 26 is obtained, which is at least illustrated in part here, by way of a buildup of fiber layers 25. A mold for producing the green body 26 is not required, it is instead sufficient to arrange the fiber layers 25 on a flat underground 27.

1. A method for producing a fiber composite component for high-temperature applications, in particular a workpiece carrier for providing and handling workpieces in high-temperature furnaces for high-temperature treatments or the like, a dimensionally stable green body of the fiber composite component being realized from a matrix material reinforced with fibers, said fiber composite component being realized by means of a heat treatment of the green body,
wherein a fiber is extruded together with a slip as a matrix material from a nozzle and is spatially arranged in such a manner that the green body is realized by means of additive manufacturing.

2. The method according to claim 1,
wherein the fibers are arranged in a structured fiber composite.

3. The method according to claim 1,
wherein the slip is dimensionally stabilized after having been extruded, said dimensional stabilizing preferably being effected by drying, heat treating or curing a binder.

4. The method according to claim 1,
wherein the fiber is freely deposited during the extrusion.

5. The method according to claim 1,
wherein the green body is re-treated in a subsequent method step by way of pressing or vacuum molding.

6. The method according to claim 1,
wherein the green body is realized so as to be shapeless or in a shape of the green body by way of an extrusion.

7. The method according to claim 1,
wherein an inorganic matrix material is used as the matrix material, preferably a matrix material made from aluminum oxide, mullite, zirconium oxide, yttrium-aluminum garnet, silicon carbide and/or silicon nitride.

8. The method according to claim 1,
wherein the slip includes a dispersing agent, preferably water, glycerine and/or ethyl alcohol being used as the dispersing agent.

9. The method according to claim 1,
wherein the slip is thixotropic.

10. The method according to claim 1,
wherein the slip includes additives, a binding agent and/or an antifoaming agent being used as additives.

11. The method according to claim 1,
wherein the slip includes 20 percent by volume of small ceramic particles having a mean particle size of 0.1 μm and 80 percent by volume of large ceramic particles having a mean particle size of 1 to 5 μm being used.

12. The method according to claim 1,
wherein the slip has a solids content of 35 percent by volume to 55 percent by volume.

13. The method according to claim 1,
wherein a fiber made from aluminum oxide, mullite, zirconium oxide, yttrium-aluminum garnet, silicon carbide and/or silicon nitride is used as the fiber.

14. The method according to claim 1,
wherein a fiber made from carbon is used as the fiber.

15. The method according to claim 1,
wherein the fiber has a diameter of 5 μm to 30 μm.

16. The method according to claim 1,
wherein the fiber is a continuous filament that is continuously supplied to the nozzle.

17. The method according to claim 1,
wherein a filament yarn is extruded from the nozzle together with the slip, said filament yarn having 1.000 den to 50.000 den.

18. The method according to claim 1,
wherein
the fiber composite component is realized so as to have a fiber content of 10 percent by volume to 60 percent by volume.

19. The method according to claim 1,
wherein the fiber composite component is realized as a workpiece carrier that is made of a support grid for positioning workpieces on the workpiece carrier, said support grid being made of support struts realizing a grid structure.

20. The method according to claim 19,
wherein intersecting points or junction points of the grid structure are realized so as to have the same material thickness and/or the same fiber content.

21. A fiber composite component for high-temperature applications, in particular a workpiece carrier for providing and handling workpieces in high-temperature furnaces for high-temperature treatments or the like, the fiber composite component being realized from a dimensionally stable green body made from a matrix material reinforced with fibers, said fiber composite component being realized by means of a heat treatment of the green body, wherein the green body is realized by means of additive manufacturing by way of a spatial arrangement and of an extrusion of a fiber together with a slip as a matrix material from a nozzle.
